(19) United States
(12) Patent Application Publication
(10) Pub. No.: US 2026/0130400 A1
(43) Pub. Date: May 14, 2026

(54) EDIBLE OIL-IN-WATER (O/W) EMULSION COMPRISING PEA PROTEIN

(71) Applicant: SOCIETE DES PRODUITS NESTLE S.A., Vevey (CH)

(72) Inventors: Alexander LUCKAS, Assling (DE); Katharina DAIMER, Freimettigen (CH); Luca GOSTELI, Bern (CH); Jiyuan Elva DONG, Gumligen (CH); Armand ROUCHER, Lausanne (CH)

(21) Appl. No.: 18/997,250

(22) PCT Filed: Jul. 26, 2023
(86) PCT No.: PCT/EP2023/070769

§ 371 Date: Jan. 21, 2025

(30) Foreign Application Priority Data
Jul. 27, 2022 (EP) 22187324.3

(51) Int. Cl. A23L 9/20; A23C 11/06; A23C 11/10; A23D 7/005; A23D 7/05; A23L 11/70; A23L 33/115; A23L 33/185; A23L 35/00; A23P 30/40

(52) U.S. Cl. CPC A23L 9/24; A23C 11/06; A23C 11/10; A23D 7/0053; A23D 7/05; A23L 11/70; A23L 33/115; A23L 33/185; A23L 35/10; A23P 30/40

(57) ABSTRACT

The present invention relates to an edible oil-in-water (o/w) emulsion comprising, based on the total weight of the emulsion, (a) from 50 to 80 wt % of an aqueous phase, (b) from 20 to 50 wt % of a vegetable lipid phase, and (c) from 0.25 to 1.50 wt % plant-based protein, (d) optionally an acidity regulator, wherein pea protein constitutes at least 50 wt % of all plant-based proteins present in the emulsion, and wherein said emulsion is substantially free, preferably free, from ingredients of dairy and animal origin. The invention also relates whipped creams thereof, and a process for the manufacture of edible o/w emulsions.

### FIELD OF THE INVENTION

The present invention relates to edible oil-in-water (o/w) emulsions comprising pea proteins, whipped creams thereof, and a process for the manufacture of edible o/w emulsions.

### BACKGROUND OF THE INVENTION

The market for plant-based alternatives has been growing strongly in recent years. The plant-based food sector in Europe grew by almost 50% from 2017 to 2020, and in Germany alone the market grew by 76% in 2020. The market includes products such as plant-based meat, plant-based milk, plant-based yoghurt, plant-based cheese, plant-based ice cream and plant-based cream.

Plant-based creams, which are often referred to as Dairy Cream Alternatives (DCA) are known in the art. Conventional plant-based creams are o/w emulsions based on vegetable fat or fat blends. However, conventional plant-based creams typically contain additives such as thickeners, stabilisers and/or emulsifiers, and a wide range of such additives are described in the prior art. For example, EP 0 294 119 A1, EP 0 436 994 B1, EP 0 455 288 A1 and WO 94/17672 A1 describe plant-based whipping creams comprising e.g. caseinates, lecithins, mono- and diglycerides, and polyoxyethylene sorbitan monostearates as emulsifiers.

WO 2012/130611 describes edible plant-based creams that can be used in whipping applications or as a food additive. However, these emulsions contain sucrose fatty acid esters in addition to other dairy-based ingredients, such as skim milk powder.

One reason for the extensive use of thickeners, emulsifiers and specific fat blends in plant-based creams is that plant-based proteins behave differently in o/w emulsions than their dairy counter-parts. These disadvantages have been countered by using a variety of thickeners, emulsifiers and specific fat blends that are often rather exotic and entirely synthetic, which may be unacceptable for the consumer.

There is a clear trend that consumers in general prefer food products, whether plant-based or not, that have a “clean label”. As will be understood this is nevertheless challenging as far plant-based creams are concerned.

WO 2021/048344 describes plant-based whipping creams containing plant-based proteins. Although a large number of vegetable proteins are mentioned in WO 2021/048344, the only detailed working example was carried out with faba bean protein. It was demonstrated that acceptable whipped creams could be produced without necessarily including thickeners and emulsifiers, although the comparative whipped cream, which contains lecithin and guar gum, still showed a superior overrun.

There is a need for plant-based whipping creams that do not contain any added thickeners and/or stabilisers and/or emulsifiers and which are free from any ingredients of dairy or animal origin, while still providing excellent whipping properties with respect to overrun, hardness, taste and/or shape retention.

Furthermore, there is also a need for a simplified process of making plant-based whipped creams.

### SUMMARY OF THE INVENTION

The present inventors have surprisingly discovered that pea protein confers superior whipping properties to the o/w emulsions as compared to other vegetable proteins. In particular, the present inventors discovered that pea protein provides improved properties to plant-based o/w emulsions, and the whipped creams thereof, as compared to faba bean protein. Based on the disclosure in WO 2021/048344 that faba bean protein can be used in whipping creams, the present inventors were indeed surprised by the observation that further improvements could be obtained by replacing faba bean protein with pea protein.

Accordingly, in a first aspect the present invention relates to an edible oil-in-water (o/w) emulsion comprising, based on the total weight of the emulsion,
(a) from 50 to 80 wt % of an aqueous phase,
(b) from 20 to 50 wt % of a vegetable lipid phase, and
(c) from 0.25 to 1.50 wt % plant-based protein,
(d) optionally an acidity regulator,
   wherein pea protein constitutes at least 50 wt % of all plant-based proteins present in the emulsion, and
   wherein said emulsion is substantially free, preferably free, from ingredients of dairy and animal origin.

In a second aspect the present invention relates to a whipped cream obtainable by whipping the emulsion of the invention. The second aspect of the present invention may alternatively be expressed as a whipped cream obtainable by incorporating air into the emulsion of the invention.

In a third aspect the present invention relates to a food product comprising the emulsion of the invention.

In a fourth aspect the present invention concerns a food product comprising the whipped cream of the invention.

Finally, in a fifth aspect, the present invention relates to a process for the manufacture of an edible oil-in-water (o/w) emulsion according to the invention comprising the following steps:
(a) providing and heating a vegetable lipid phase;
(b) providing, and optionally heating, an aqueous phase comprising a plant-based protein, wherein pea protein constitutes at least 50 wt % of all plant-based proteins present in the aqueous phase;
(c) mixing said aqueous and vegetable lipid phases so as to form a pre-emulsion;
(d) homogenising said pre-emulsion obtained in step (c) so as to obtain an o/w emulsion;
(e) cooling said emulsion obtained in step (d);
(f) subjecting said cooled emulsion obtained in step (e) to UHT treatment;
(g) homogenising said UHT-treated emulsion obtained in step (f); and
(h) cooling said homogenised and UHT-treated emulsion obtained in step (g),
wherein the pH may optionally be adjusted by an acidity regulator after any of steps (b) to (h) so as to obtain a pH in the range from 6.5 to 7.5.

### DESCRIPTION OF THE FIGURES

FIG. 1 shows the maximum overrun of the whipped emulsion #1 to #6 prepared in laboratory scale. The whipped emulsions #1 to #3 contain faba bean protein, whereas the whipped emulsions #4 to #6 contain pea protein. More details are provided in Tables 4 and 5.

FIG. 2 shows the maximum overrun of the whipped emulsion #6 to #9 prepared on industrial scale. The whipped emulsions contain pea protein. The whipped emulsions #6 and #7 contain Fat blend 1, whereas the whipped emulsions #8 and #9 contain Fat blend 2. More details are provided in Tables 4 and 6.

FIG. 3 shows the shape retention of whipped emulsions #6, #8 and #9 immediately after piping and 45 minutes after piping.

FIG. 4 shows the application of whipped emulsion #8 in a vegan cheesecake.

FIG. 5 shows a flow chart of the manufacturing process.

### DETAILED DESCRIPTION OF THE INVENTION

### Definitions

The terms “emulsion”, “edible emulsion” and “cream” are used synonymously herein. In a similar way, the terms “whipped emulsion” and “whipped cream” are used interchangeably. Also the terms “vegetable” and “plant-based” are used synonymously herein. All emulsions described herein are oil-in-water (o/w) emulsions unless otherwise stated. All fats and oil described herein are of vegetable origin unless otherwise stated. All percentages and ratios are by weight unless otherwise indicated.

The term “whipping cream” (or “whipping emulsion”) is used in its normal meaning, i.e. as defined in point 2.4.2 of the Codex Alimentarius (Standards for cream and prepared creams, CXS 288-1976): “Whipping cream is the fluid cream, reconstituted cream and/or recombined cream that is intended for whipping. When cream is intended for use by the final consumer the cream should have been prepared in a way that facilitates the whipping process”.

Likewise, the term “whipped cream” (or “whipped emulsion”) is also used in its normal meaning, i.e. as defined in point 2.4.4 of the Codex Alimentarius (Standards for cream and prepared creams, CXS 288-1976): “Whipped cream is the fluid cream, reconstituted cream and/or recombined cream into which air or inert gas has been incorporated without reversing the fat-in-skimmed milk emulsion”. Since the whipped cream of the present invention does not contain milk, the last part of the definition, i.e. “[ . . . ] without reversing the fat-in-skimmed milk emulsion” should be replaced with “[ . . . ] without reversing the oil-in-water emulsion”.

In the present context a protein “isolate” is considered a dry product that contains at least 70 wt % of the protein in question. In a similar way, a protein “concentrate” is considered a dry product that contains at least 50 wt % of the protein in question.

When used herein, the term “substantially free from” means that the quantity of the ingredient to which it refers is only present in trace amounts and is not intentionally added. More particularly, the term “substantially free from X” means that the emulsion of the invention contains at the most 0.5 wt % X based on the total weight of the emulsion, preferably at the most 0.25 wt % X based on the total weight of the emulsion, more preferably at the most 0.1 wt % X based on the total weight of the emulsion, even more preferable at the most 0.05 wt % X based on the total weight of the emulsion, most preferable at the most 0.01 wt % X based on the total weight of the emulsion.

In the present context, the term “liquid oil” refers to a triglyceride (lipid), or a mixture of triglycerides, that is completely liquid at 20° C.

Analogously, the term “solid fat” refers to a triglyceride (lipid), or a mixture of triglycerides, that contains some solid fat at 20° C. In particular, a “solid fat” has a solid fat content (SFC) of at least 20 wt % at 20° C. SFC may routinely be determined by e.g. pulsed NMR or DSC as known to the person skilled in the art. Moreover, SFC curves for a large number of fats and fat blends are available from text- and handbooks, such as Gunstone, Vegetable Oils in Food Technology-Composition, Properties and Uses (2011); Gunstone, Modifying lipids for use in food (2006); Rajah, Fats in Food Technology (2002); and Gunstone, Harwood and Dijkstra, The Lipid Handbook (2007). SFC curves for commercially available fats and fat blends are typically provided by the manufacturer when the fats and fat blends in question are purchased.

A “thickener” or “thickening agent” is an additive, which can increase the viscosity of a liquid without substantially changing its other properties. Thickeners are commonly used to thicken sauces, soups, and puddings without altering their taste. A list of thickeners, which are accepted for use in e.g. whipping creams, is provided in point 4 of the Codex Alimentarius (Standards for cream and prepared creams, CXS 288-1976). As will be understood, the emulsion of the present invention is preferably substantially free from thickeners, more preferably the emulsion of the present invention is free from thickeners.

A “stabiliser” or “stabilising agent” is an additive that aids in preserving the structure of a food product. A list of stabilisers, which are accepted for use in e.g. whipping creams, is provided in point 4 of the Codex Alimentarius (Standards for cream and prepared creams, CXS 288-1976). As will be understood, the emulsion of the present invention is preferably substantially free from stabilisers, more preferably the emulsion of the present invention is free from stabilisers.

An “emulsifier” or “emulsifying agent” is an additive that stabilises an emulsion, such as an o/w emulsion, by lowering the surface tension of the immiscible liquids present in the emulsion. As will be known to the person skilled in the art, proteins may act as emulsifiers and hence stabilise o/w emulsions. A list of emulsifiers, which are accepted for use in e.g. whipping creams, is provided in point 4 of the Codex Alimentarius (Standards for cream and prepared creams, CXS 288-1976). As will be understood, the emulsion of the present invention is preferably substantially free from emulsifiers with the exception of plant-based protein, more preferably the emulsion of the present invention is free from emulsifiers with the exception of plant-based protein.

“UHT” is an abbreviation for “ultra high temperature” and involves heating at 135 to 150° C. for a few seconds.

The term “and/or” when used in the context of “X and/or Y” should be interpreted as “X”, or “Y”, or “X and Y”.

In the present context, the singular forms “a”, “an”, and “the” include both singular and plural form. For example, the wording “an o/w emulsion comprising a plant-based protein” means that one or more plant-based protein may be present in the o/w emulsion.

### The Edible o/w Emulsions

The o/w emulsion of the present invention is substantially free, preferably free, from ingredients of dairy or animal origin, and comprises from 50 to 80 wt % of an aqueous phase, from 20 to 50 wt % of a vegetable lipid phase, and from 0.25 to 1.50 wt % plant-based protein, wherein pea protein constitutes at least 50 wt % of all plant-based proteins present in the emulsion.

In a preferred embodiment of the invention, pea protein constitutes at least 60 wt % of all plant-based proteins present in the emulsion, more preferably pea protein constitutes at least 70 wt % of all plant-based proteins present in the emulsion, even more preferably pea protein constitutes at least 80 wt % of all plant-based proteins present in the emulsion, still more preferably pea protein constitutes at least 90 wt % of all plant-based proteins present in the emulsion. In particular, pea protein constitutes at least 95 wt % or at least 99 wt % of all plant-based proteins present in the emulsion.

In the most preferred embodiment, the pea protein is the only protein in the emulsion.

The emulsion may comprise thickeners, stabilisers and/or emulsifiers. The thickeners, stabilisers and/or emulsifiers are not of dairy and animal origin.

In a preferred embodiment, the emulsion has a “clean label” in the sense that the emulsion is substantially free from thickeners, stabiliser and emulsifiers. In particular, the emulsion is free from thickeners, stabiliser and emulsifiers. As will be understood, the term “(substantially) free from emulsifiers” does not include the plant-based proteins per se, which have emulsifying properties and hence assists in stabilising the emulsion. In an alternative embodiment the emulsion is free from one or more components selected from the group consisting of thickeners, stabilizers, emulsifiers or a combination thereof. The emulsion of the invention is also substantially free from ingredients of dairy and animal original origin. In particular, the emulsion of the invention is free from ingredients of dairy and animal original origin. Thus, in a preferred embodiment, the emulsion of the invention is a vegan emulsion.

As will be understood, it is highly preferred that pea protein is the only protein in the emulsion, and that the emulsion is substantially fee from thickeners and/or emulsifiers and/or emulsifiers with the exception of said plant-based protein. In other words, in its most preferred embodiment, the present invention is directed to an edible oil-in-water (o/w) emulsion comprising, based on the total weight of the emulsion,
(a) from 50 to 80 wt % of an aqueous phase,
(b) from 20 to 50 wt % of a vegetable lipid phase, and
(c) from 0.25 to 1.50 wt % pea protein,
(d) optionally an acidity regulator,
   wherein said pea protein is the only protein present in the emulsion,
   wherein said emulsion is substantially free from thickeners and/or emulsifiers and/or emulsifiers with the exception of said plant-based protein,
   wherein said emulsion is substantially free, preferably free, from ingredients of dairy and animal origin.

In an embodiment of the invention, the emulsion also comprises an acidity regulator. The acidity regulator must of course be edible. The skilled person is well aware of such edible acidity regulators, and specific examples include lactic acid and citric acid and mixtures thereof. Citric acid is particularly preferred. The edible acid regulators may also be added be added in the form of salts of the acid regulators, such as in the form of the sodium, potassium or calcium salts thereof.

The fat droplets in the emulsion are sufficiently small to ensure a stable emulsion. In particular, the volume-based mean diameter, D[4;3], of the fat droplets in the emulsion is typically in the range from 0.1 to 5 μm, preferably in the range from 0.25 to 3 μm, more preferably in the range from 0.25 to 2 μm, even more preferably in the range from 0.25 to 1.5 μm, most preferably in the range from 0.5 to 1 μm. Accordingly, it is in generally preferred that the volume-based mean diameter, D[4;3], of the fat droplets in the emulsion is smaller than 2 μm, such as smaller than 1.5 μm, in particular smaller than 1 μm.

The pH of the emulsion is typically between 6 and 8, preferably between 6.0 and 7.5, more preferably between 6.5 and 7.1, even more preferably between 6.6 and 7.0, most preferably between 6.7 and 6.9, in particular between 6.75 and 6.85, such as about 6.8.

The emulsion may also comprise other commonly used ingredients, such as sugar, sweeteners, flavourings, aroma compounds and combinations thereof. The emulsion may also comprise anti-oxidants or preservatives to improve its shelf-life. As will be understood, in such cases the above-mentioned ingredients are not of non-natural, animal and dairy origin, but are of vegetable origin.

### Plant-Based Proteins

Proteins serve as an important nutritional ingredient in food products and play, due to their functional (surface-active) properties, an important role in providing structure and stability to food products. In particular, it is well known that proteins may act as natural emulsifiers and hence stabilise o/w emulsions.

As mentioned previously, it is generally preferred that pea protein is the only protein in the emulsion, but other plant-based based proteins may be present, provided that pea protein constitutes at least 50 wt % of all plant-based proteins present in the emulsion.

Accordingly, based on the total amount of plant-based protein present in the emulsion, the emulsion may comprise less than 50 wt % plant-based protein different from pea protein, preferably less than 40 wt % plant-based protein different from pea protein, more preferably less than 30 wt % plant-based protein different from pea protein, even more preferably less than 20 wt % plant-based protein different from pea protein, still more preferably less than 10 wt % plant-based protein different from pea protein. In particular, based on the total amount of plant-based protein present in the emulsion, the emulsion comprises less than 5 wt % or less than 1 wt % plant-based protein different from pea protein.

Plant-based proteins, which are different from pea protein, that may be incorporated in the emulsion may be obtained from e.g. legumes, oil seeds, nuts and cereals.

Examples of plant-based proteins from legumes include alfalfa, clover, tamarind, kidney bean, navy bean, pinto bean, black turtle bean, haricot bean, lima bean, butter bean, adzuki bean, azuki bean, mung bean, golden gram, green gram, black gram, urad, scarlet runner bean, ricebean, moth bean, tepary bean, horse bean, broad bean, field bean, chickpea, garbanzo, bengal gram, dry cowpea, black-eye bean, congo bean, andules, lentil, bambara groundnut, vetch, common vetch, lupins, lablab, hyacinth bean, jack bean, sword bean, winged bean, velvet bean, cowitch and yam bean.

Examples of plant-based proteins from oil seeds include soybean, cottonseed, peanut, sunflower, canola and coconut.

Examples of plant-based proteins from nuts include almond, brazil nut, hazel nut, walnut, pecan nut, candle nut, cashew nut, chestnut, macadamia nut, mongongo, pili nut, pine nut, pistachio nut and yeheb nut, in particular almond.

Examples of plant-based proteins from cereals include oat, amaranth, barley, rice, buckwheat, corn, wheat, millet, quinoa, rye, sorghum, spelt, teff and triticale, in particular oat.

In case the emulsion comprises plant-based proteins different from pea protein, the plant-based protein is preferably almond protein, oat protein or a combination of almond and oat protein.

### Pea Protein

In the most preferred embodiment of the invention, the pea protein is the only protein in the emulsion.

Pea belong to the legume family and is one of the most important legumes worldwide. Pea contains about 25 wt % protein. However, vegetable proteins, including pea protein, have different functional properties and a different nutritional value as compared to dairy proteins.

The protein quality of pea protein is relatively high as compared to other vegetable proteins. By way of example, pea protein has a Protein Digestitibility Corrected Amino Acid Score (PDCAAS) of 84 (the PDCAAS of milk proteins is 100). In a similar way, due to the differences in amino acid composition, three-dimensional structure, folding and surface hydrophobicity, dairy proteins and plant-based proteins, including pea protein, do not have the same functional properties. As demonstrated herein, the present inventors found that pea protein surprisingly has excellent emulsifying properties and may hence be used as the sole emulsifier in the o/w emulsions of the invention.

The term “pea protein” encompasses intact pea protein as well as hydrolysed, including partially and extensively hydrolysed, pea protein. Pea protein is commercially available in the form of concentrates and isolates from a number of suppliers such as AGT Food Ingredients, Cosucra and Cargill.

The emulsion may comprise from 0.25 to 1.50 wt % pea protein based on the total weight of the emulsion. Typically, the emulsion comprises from 0.50 to 1.25 wt % pea protein based on the total weight of the emulsion, preferably from 0.75 to 1.25 wt % pea protein based on the total weight of the emulsion, more preferably from 0.80 to 1.25 wt % pea protein based on the total weight of the emulsion, most preferably from 0.90 to 1.20 wt % pea protein based on the total weight of the emulsion.

The pea protein may be incorporated in the emulsion in the form of either a pea protein concentrate or a pea protein isolate, preferably in the form of a pea protein isolate. Moreover, the pea protein may be in the form of an intact pea protein or a hydrolysed pea protein. The hydrolysed pea protein may be either partially or extensively hydrolysed.

### The Aqueous Phase

Water is the main constituent in the aqueous phase of the emulsion. It is important to note that when the emulsion of the invention is stated to comprise “X wt % of an aqueous phase” reference is made to the total weight of the aqueous phase, i.e. the total weight of water and any ingredient(s) that may be dissolved or suspended in the aqueous phase. By way of example, if the emulsion of the invention contains 67 wt % water, 30 wt % of a vegetable lipid phase, as well as 1 wt % pea protein and 2 wt % sugar dissolved in the water, the aqueous phase makes up 50 wt % of the emulsion.

The emulsion of the invention comprises from 50 to 80 wt % of an aqueous phase, based on the total weight of the emulsion.

The emulsion of the invention typically comprises from 55 to 75 wt % of the aqueous phase, preferably from 60 to 75% wt % of the aqueous phase, more preferably from 65 to 75 wt % of the aqueous phase, most preferably from 68 to 72 wt % of the aqueous phase, based on the total weight of the emulsion.

Since water is the main constituent in the aqueous phase of the emulsion, the above-mentioned weight percentages of the aqueous phase correspond largely to the weight percentages of water present in the emulsion. In other words, the emulsion of the invention typically contains from 50 to 80 wt % water, based on the total weight of the emulsion, such as from 55 to 75 wt % water, preferably from 60 to 75% wt % water, more preferably from 65 to 70 wt % water, most preferably from 68 to 70 wt % water, based on the total weight of the emulsion.

As will be understood, when the emulsion of the invention contains X wt % of the aqueous phase it is counterbalanced by (100-X) wt % of a vegetable lipid phase (vide infra). Thus, the emulsion of the invention may comprise from 55 to 75 wt % of the aqueous phase and from 25 to 45 wt % of the lipid phase, preferably from 60 to 75% wt % of the aqueous phase and from 25 to 40% wt % of the lipid phase, more preferably from 65 to 75 wt % of the aqueous phase and from 25 to 35 wt % of the lipid phase, most preferably from 68 to 72 wt % of the aqueous phase and from 28 to 32 wt % of the lipid phase, such as about 70 wt % of the aqueous phase and about 30 wt % of the lipid phase.

### The Vegetable Lipid Phase

The vegetable lipid phase constitutes 20 to 50 wt % of the emulsion. Typically the emulsion comprises from 25 to 45 wt % of the lipid phase, preferably from 25 to 40% wt % of the lipid phase, more preferably from 25 to 35 wt % of the lipid phase, most preferably from 28 to 32 wt % of the lipid phase.

As will be understood, when the emulsion of the invention contains Y wt % of the vegetable lipid phase it is counterbalanced by (100-Y) wt % of an aqueous phase (vide supra). Thus, the emulsion of the invention may comprise from 55 to 75 wt % of the aqueous phase and from 25 to 45 wt % of the lipid phase, preferably from 60 to 75% wt % of the aqueous phase and from 25 to 40% wt % of the lipid phase, more preferably from 65 to 75 wt % of the aqueous phase and from 25 to 35 wt % of the lipid phase, most preferably from 68 to 72 wt % of the aqueous phase and from 28 to 32 wt % of the lipid phase, such as about 70 wt % of the aqueous phase and about 30 wt % of the lipid phase.

In a first embodiment of the invention, the vegetable phase comprises, preferably consists of, a blend of a vegetable liquid oil and a vegetable solid fat.

The blend may contain from 10 to 50 wt % vegetable liquid oil and from 50 to 90 wt % vegetable solid fat, preferably from 15 to 45 wt % vegetable liquid oil and from 55 to 85 wt % vegetable solid fat, more preferably from 20 to 40 wt % vegetable liquid oil and from 60 to 80 wt % vegetable solid fat. Alternatively, the blend may preferably contain from 10 to 30 wt % vegetable liquid oil and from 70 to 90 wt % vegetable solid fat, more preferably from 15 to 25 wt % vegetable liquid oil and from 75 to 85 wt % vegetable solid fat, most preferably from 17.5 to 22.5 wt % vegetable liquid oil and from 77.5 to 82.5 wt % vegetable solid fat. As a further alternative, the blend may preferably contain from 30 to 50 wt % vegetable liquid oil and from 50 to 70 wt % vegetable solid fat, more preferably from 35 to 45 wt % vegetable liquid oil and from 55 to 65 wt % vegetable solid fat, most preferably from 37.5 to 42.5 wt % vegetable liquid oil and from 57.5 to 62.5 wt % vegetable solid fat.

In this embodiment of the invention, it is preferred that the blend itself has a vegetable solid fat content (SFC) of at least 50 wt % at 20° C., more preferably an SFC of at least 60 wt % at 20° C., even more preferably an SFC of at least 70 wt % at 20° C., most preferably an SFC of at least 80 wt % at 20° C.

In this embodiment of the invention, it is also preferred that the vegetable solid fat itself has a vegetable solid fat content (SFC) of at least 50 wt % at 20° C., more preferably an SFC of at least 60 wt % at 20° C., even more preferably an SFC of at least 70 wt % at 20° C., most preferably an SFC of at least 80 wt % at 20° C.

In a preferred embodiment of the invention, the said blend contains from 10 to 30 wt % vegetable liquid oil and from 70 to 90 wt % vegetable solid fat.

In an alternative embodiment of the invention, the blend contains from 30 to 50% vegetable liquid oil, and from 50 to 70% solid fat. This embodiment of the invention has been found to be particular suitable for storage at high ambient temperature for example at temperatures in the range of 25 to 30° C. for a shelf life up to 9 months.

Specific examples of vegetable solid fats that are suitable for this first embodiment of the invention include: hydrogenated palm kernel oil, palm stearin, hard palm mid fraction and cocoa butter. An example of a suitable commercially available product is Akotop NT70 from AAK or comparables.

A number of vegetable liquid oils are useful for this first embodiment of the invention, and a large number of suitable vegetable oils, including their fatty acid profiles, can be found in Dubois et al, Eur J Lipid Sci Technol, 2007; 109; 710-732. Specific examples of suitable vegetable liquid oils may be selected from the group consisting of coconut oil, palm oil, palm kernel oil, canola oil, peanut oil, rapeseed oil, linseed oil, grapeseed oil, cottonseed oil, soybean oil, corn oil, sunflower oil, and combinations thereof, especially sunflower oil.

In a particular preferred embodiment of the invention, the vegetable liquid oil has a high oleic content, such as an oleic content of at least 70 wt %, e.g. at least 75 wt %. Specific examples of suitable vegetable liquid oils with a high oleic content may be selected from the group consisting of high oleic sunflower oil, high stearic high oleic sunflower oil, high oleic safflower oil, high oleic soybean oil, high oleic rapeseed oil, high oleic canola oil, high oleic algal oil, high oleic palm oil, high oleic peanut oil, olive oil, macademia nut oil, moringa oleifera seed oil, hazelnut oil, avocado oil, and combinations thereof. High oleic sunflower oil (HOSO) is particularly preferred.

In a second embodiment of the invention, the vegetable phase comprises, preferably consists of, a blend of a first vegetable solid fat and a second vegetable solid fat.

The first vegetable solid fat is typically present in the blend in an amount from 80 to 99 wt %, and said second vegetable solid fat is typically present in the blend in an amount from 1 to 20 wt %, preferably said first vegetable solid fat is present in the blend in an amount from 85 to 95 wt %, and said second vegetable solid fat is present in the blend in an amount from 5 to 15 wt %, more preferably said first vegetable solid fat is present in the blend in an amount from 88 to 93 wt %, and said second vegetable solid fat is present in the blend in an amount from 7 to 12 wt %, most preferably said first vegetable solid fat is present in the blend in an amount from 90 to 92 wt %, and said second vegetable solid fat is present in the blend in an amount from 8 to 10 wt %.

In this embodiment of the invention it is preferred that the blend itself has a vegetable solid fat content (SFC) of at least 50 wt % at 20° C., more preferably an SFC of at least 60 wt % at 20° C., even more preferably an SFC of at least 65 wt % at 20° C., most preferably an SFC of at least 70 wt % at 20° C.

In this embodiment of the invention it is also preferred that said first vegetable solid fat has a solid fat content (SFC) of 20 to 40 wt % at 20° C. and said second vegetable solid fat has a solid fat content (SFC) of at least 80 wt % at 20° C., more preferably said first vegetable solid fat has an SFC of 25 to 40 wt % at 20° C. and said second vegetable solid fat has an SFC of at least 85 wt % at 20° C., most preferably said first vegetable solid fat has an SFC of 25 to 40 wt % at 20° C. and said second vegetable solid fat has an SFC of at least 90 wt % at 20° C.

Specific examples of the first vegetable solid fats include palm oil, coconut oil and palm kernel oil. An example of a suitable commercially available product is Akotop NT70 from AAK or similar products.

Specific examples of the second vegetable solid fats include shea stearin, hydrogenated palm kernel oil and hard palm mid fraction. An example of a suitable commercially available product is Chocofill TC 90 from AAK.

### Thickeners, Stabilisers and Emulsifiers

As mentioned previously, it is generally preferred that the emulsion is substantially free, preferably free, from thickeners and/or stabilisers and/or emulsifiers with the exception of the plant-based protein.

However, in order to further stabilise the emulsion and/or to increase the viscosity of the emulsion, the emulsion may contain thickeners, stabilisers and/or emulsifiers. If present, emulsifiers are typically present in an amount from 0.01 to 2 wt % based on the total weight of the emulsion, preferably in an amount from 0.02 to 1 wt % based on the total weight of the emulsion, more preferably in an amount from 0.025 to 0.5 wt % based on the total weight of emulsion.

Specific examples of suitable emulsifiers are disclosed in point 4 of the Codex Alimentarius (Standards for cream and prepared creams, CXS 288-1976). A particularly preferred emulsifier is lecithin.

Specific examples of suitable stabilizers and thickeners are disclosed in point 4 of the Codex Alimentarius (Standards for cream and prepared creams, CXS 288-1976). Preferred examples include gum Arabic (acacia gum) and guar gum. If present, stabilisers and/or thickeners are typically incorporated in an amount from 0.01 to 5 wt % based on the total weight of the emulsion, preferably in an amount from 0.02 to 3 wt % based on the total weight of the emulsion, more preferably in an amount from 0.025 to 1 wt % based on the total weight of emulsion.

that pea protein is the only protein in the emulsion, but other plant-based based proteins may be present, provided that pea protein constitutes at least 50 wt % of all plant-based proteins present in the emulsion.

### Manufacture of the o/w Emulsions

The present invention is also directed to a process for the manufacture of an edible oil-in-water (o/w) emulsion according to the invention comprising the following steps:
(a) providing and heating a vegetable lipid phase;
(b) providing, and optionally heating an aqueous phase comprising a plant-based protein, wherein pea protein constitutes at least 50 wt % of all plant-based proteins present in the aqueous phase;
(c) mixing said aqueous and vegetable lipid phases so as to form a pre-emulsion;
(d) homogenising said pre-emulsion obtained in step (c) so as to obtain an o/w emulsion;
(e) cooling said emulsion obtained in step (d);
(f) subjecting said cooled emulsion obtained in step (e) to UHT treatment;
(g) homogenising said UHT-treated emulsion obtained in step (f); and
(h) cooling said homogenised and UHT-treated emulsion obtained in step (g),
wherein the pH may optionally be adjusted by an acidity regulator after any of steps (b) to (h) so as to obtain a pH in the range from 6.5 to 7.5, preferably in the range from 6.6 to 7.0, more preferably in the range from 6.7 to 6.9, most preferably about 6.8.

As will be understood, all statements made above with respect to ingredients, amounts, preferred embodiments, etc. apply mutatis mutandis to the present section directed to the manufacture of the o/w emulsions.

The process may be carried out as a batch process or as a continuous process. A continuous process is preferred.

In a preferred embodiment of the invention, steps (a) to (h) are carried out in the sequence indicated above with the exception that steps (a) and (b) may be reversed or carried out in parallel. In other words, it is preferred that steps (a) and (b) are succeeded by step (c), that step (c) is succeeded by step (d), that step (d) is succeeded by step (e), that step (e) is succeeded by step (f), that step (f) is succeed by step (g), and that step (g) is succeeded by step (h).

In step (a) of the process, the vegetable lipid phase is melted by heating the lipid vegetable phase. The exact temperature to be used is of course dependent on the melting temperature of the used lipid. Typical temperatures to be used are in the range from 40 to 80° C., such as from 50 to 70° C., e.g. from 60 to 70° C. The vegetable lipid phase is typically stirred while being heated.

In step (b) of the process, the plant-based protein is dissolved or dispersed in the aqueous phase. Whether heating is needed or not depends on the type and concentration of plant-based protein. It is most common that the aqueous phase is heated to a temperature, which is typically in the range from 40 to 80° C., such as from 50 to 70° C., e.g. from 60 to 70° C. The aqueous phase is typically stirred while being heated.

In step (c) of the process, the aqueous phase and the liquid phase are mixed so as to obtain a pre-emulsion. The mixing step is preferably carried out with a mixing equipment, and under conditions, where a relatively high shear is provided to the mixture. Suitable mixing equipment and mixing conditions are known to the skilled person and is described in, for example, Cullen, Food Mixing: Principles and Applications, 2009; and in Paul et al, Handbook of Industrial Mixing-science and practice, 2004. Specific examples of suitable mixers include impellers, such as propeller mixers, turbine mixers and paddle mixers, static (motionless) mixers and rotor stator mixers. The mixing step (c) may be performed as a batch process, i.e. a batch of the vegetable lipid phase from step (a) is mixed with the aqueous phase from step (b) in an appropriate mixer. However, in a preferred embodiment, the mixing step (c) is part of a continuous process where the vegetable lipid phase from step (a) and the aqueous phase from step (b) are continuously to an in-line mixer, e.g. an in-line static mixer or an in-line rotor stator mixer. Thus, in a preferred embodiment of the invention step, the mixer used in the mixing step (c) is an in-line mixer.

It was found that by the present inventors that inclusion of two homogenisation steps, i.e. a homogenisation step upstream of the UHT treatment (homogenisation step (d)) and a homogenisation step downstream of the UHT treatment (homogenisation step (g)), is important in order to obtain a stable emulsion.

In step (d) of the process, homogenisation is typically carried out with a high-pressure homogeniser as is known to the skilled person. The homogenisation is preferably performed as two-stage homogenisation. When two-stage homogenisation is used, the pressure in the first stage is typically in the range from 50 to 200 bar, preferably in the range from 75 to 150 bar, more preferably in the range from 75 to 125 bar, most preferably about 100 bar. The pressure in the second stage is typically in the range from 5 to 30 bar, preferably in the range from 10 to 25 bar, more preferably from 10 to 20 bar, most preferably about 10 or about 20 bar. Accordingly, in its most preferred embodiment, the homogenisation in step (d) is performed at 50/10 or 100/20 bar, in particular 100/20 bar.

In step (e) of the process, the o/w emulsion obtained in the homogenisation step (d) is cooled, typically to a temperature in the range from 10 to 40° C., preferably in the range from 10 to 30° C., more preferably in the range from 15 to 25° C., in particular to a temperature of about 20° C.

In step (f) of the process, the cooled emulsion obtained in step (e) is subjected to UHT treatment, which will be known to the skilled person. The UHT system may be a direct system, e.g. a steam injection UHT system or a steam infusion system. Alternatively, the UHT system may be an indirect system based on, e.g., plate heat exchangers, tubular heat exchangers or scraped surface heat exchangers. UHT treatment by direct steam injection is generally preferred. The emulsion is typically heated at a temperature in the range from 135 to 150° C. for a few seconds, e.g. 1 to 10 seconds, more preferably the emulsion is heated at a temperature in the range of 140 to 150° C. for 2 to 7 seconds, in particular at a temperature of about 145° C. for about 5 seconds.

Following the UHT treatment in step (f), the emulsion is subjected to a second homogenisation step (step (g)). In a similar way as described above in connection with the homogenisation step (d), the homogenisation step (g) is typically carried out with a high-pressure homogeniser, and the homogenisation is preferably performed as two-stage homogenisation. The homogenisation pressure used in step (g) is generally higher than the homogenisation pressure used in step (d). When two-stage homogenisation is used, the pressure in the first stage is typically in the range from 150 to 350 bar, preferably in the range from 200 to 300 bar, more preferably in the range from 225 to 275 bar, most preferably about 20 bar. The pressure in the second stage is typically in the range from 25 to 100 bar, preferably in the range from 25 to 75 bar, more preferably from 40 to 60 bar, most preferably about 50 bar. Accordingly, in its most preferred embodiment, the homogenisation in step (g) is performed at 250/50 bar.

In step (h) of the process, the o/w emulsion obtained in the homogenisation step (g) is cooled, typically to a temperature in the range from 10 to 40° C., preferably in the range from 10 to 30° C., more preferably in the range from 15 to 25° C., in particular to a temperature of about 20° C.

The emulsion may then be filled into suitable containers, in particular by aseptic filling or by hot-filling.

It may be necessary to adjust the pH during the process. It is, in general, preferred that the pH of the emulsion after step (h) is between 6 and 8, more preferably between 6.0 and 7.5, even more preferably between 6.5 and 7.1, still more preferably between 6.6 and 7.0, most preferably between 6.7 and 6.9, in particular between 6.75 and 6.85, such as about 6.8.

In principle, the pH may be adjusted by an acidity regulator during or after any of steps (b) to (h) so as to obtain a pH in the range from 6.5 to 7.5, preferably in the range from 6.6 to 7.0, more preferably in the range from 6.7 to 6.9, most preferably about 6.8. It is preferred, however, that the pH of the aqueous phase in step (b) is adjusted, and/or the pH of the pre-emulsion in step (c) is adjusted and/or the pH of the cooled in step (e) or (g) is adjusted.

### Applications

In further aspects, the present invention also concerns a whipped cream obtainable by incorporating air into the emulsion of the invention. Thus, in a related aspect, the present invention is also directed to a whipped cream obtainable by whipping the emulsion of the invention. The emulsion may be whipped with a whisk, an electric hand mixer, or a food processor. The whipped cream preferably has a maximal overrun of at least 150%, such as in the range from 150 to 400%. More preferably, the whipped cream has a maximal overrun of at least 200%, such as in the range from 200 to 400%. In a more preferred embodiment, the whipped cream has a maximal overrun of at least 250%, such as in the range from 250 to 400%. In an even more preferred embodiment, the whipped cream has a maximal overrun of at least 300%, such as in the range from 300 to 400%.

The present invention also relate to a food product, including beverages, comprising the whipped cream of the invention. The food product, including beverages, may be a frozen food product. The food product may also be a dessert. The whipped cream may be used in, or applied to a food product e.g. in the form of a topping. The food product may be a dessert. Examples of food products to which the whipped emulsion may be applied as a topping include fruits, pies, ice creams, cupcakes, cakes, milkshakes, waffles, hot chocolate, coffee, cheesecakes, jello, and puddings.

In a further aspect, the present invention also concerns a food product comprising the emulsion of the invention. The food product may be a frozen food product. The emulsion may be used in virtually any of the countless food products where dairy cream is typically used, e.g. in beverages, such as coffee and hot chocolate, as well as in soups, sauces, including sauces with a low pH, such as white wine sauces

The invention is further illustrated by the following non-limiting examples.

### EXAMPLES

### Materials

Pea protein concentrate, faba bean protein isolate and faba bean protein concentrate were obtained from AGT Food and Ingredients, Canada. Pea protein isolate was obtained from Cosucra, Belgium. The protein concentration in the concentrates and isolates was determined by the Kjeldahl method, which is known by the person skilled in the art. The protein concentration in the concentrates and isolates is summarised in Table 1.

TABLE 1
Protein concentrations in pea and faba
bean isolates and concentrates.

| Protein | wt % protein |
|---|---|
| Pea protein isolate | 77.05 |
| Pea protein concentrate | 51.69 |
| Faba bean protein isolate | 83.02 |
| Faba bean protein concentrate | 54.94 |

Hydrogenated palm kernel oil (HPKO) was obtained from Fuji Oil Europe. High oleic sunflower oil (HOSO) was obtained from Oleificio Sabo. Chocofill NH 18 and shea stearin were obtained from AAK.

Two different fat blends were used in the trials. In the preliminary laboratory trials only Fat blend 1 was used, whereas in the industrial scale trials both Fat blend 1 and Fat blend 2 were used. The fat blends are shown in Table 2.

TABLE 2
Composition of Fat blends 1 and 2. The solid fat content (SFC) at
20° C. for the individual fats, including Fat blends 1 and
2 is shown in Table 3. The SFC for the individual fats is according
to the manufacturer's certificate of analysis. SFC for Fat blends
1 and 2 was determined by differential scanning calorimetry (DSC).

| Fat blend 1 | | Fat blend 2 | |
|---|---|---|---|
| | wt % in | | wt % in |
| Fat/oil | fat blend | Fat | fat blend |
| Hydrogenated palm | 80 | Chocofill NH 18 | 92 |
| kernel oil (HPKO) | | | |
| High oleic sunflower | 20 | Shea stearin | 8 |
| oil (HOSO) | | | |

TABLE 3
SFC for fats and fat blends at 20° C.

| | Solid fat content (SFC) at 20° C. |
|---|---|
| Fat | (wt %) |
| Hydrogenated palm kernel oil | 87 |
| (HPKO) | |
| Chocofill NH 18 | 32 |
| Shea stearin | >90 |
| Fat blend 1 | 85 |
| Fat blend 2 | 76 |

### Methods

### Protein Analysis

The Kjeldahl method was used to determine the protein content of the used protein concentrates and isolates. The KjelMaster K375, the KjelSampler K376 and the KjelLink software were used for this purpose. Sodium hydroxide from VWR, boric acid from Merck, sulphuric acid from Merck, buffer solutions pH 7.0 and 4.0 from Merck, and monobasic ammonium phosphate from Fluka were used as reagents.

### Differential Scanning Calorimetry (DSC)

A DSC3+ and the STARe software from Mettler Toledo was used to determine the solid fat content in the fat blends. The samples were each placed in a crucible and the crucible was sealed. Subsequently, the sample was weighed. The sealed crucible was then placed in the automatic sampler. The samples were heated from 25° C. to 60° C. at a heating rate of 10° C./min. The temperature was then held at 60° C. for 5 min before cooling to −45° C. at a cooling rate of 5° C./min. The temperature was again held for 10 min, and finally heated to 60° C. with a heating rate of 5° C./min. The resulting melting curve was integrated using the software. The solid fat content of the sample was then determined at specific temperatures using the mathematical function of the software.

### Particle Size (Fat Droplet Size)

A Malvern Mastersizer 3000 and a Hydro LV was used to measure the particle (fat droplet) size distribution. The device was switched on at least 30 minutes before the measurement and the software was started. The Mastersizer was cleaned using the cleaning program. For sample preparation, the sample was diluted to a factor between 1:2 and 1:5 with Milli-Q water, depending on the viscosity of the sample. Then enough sample was pipetted into the Hydro LV until the obscuration was within the pre-set range, and the measurement was started. The volume-based mean diameter, D[4;3], was used as the characterising particle size (fat droplet) parameter.

For the particle size (fat droplet) measurements with sodium dodecyl sulphate (SDS), about 1 ml of the previously prepared solution was added to 40 mL of a 0.5% SDS solution and shaken for five seconds before being measured as described above.

The flocculation factor (F) is defined as:

$$F = \frac{{D [ 4 ; 3 ]}_{without SDS}}{{D [ 4 ; 3 ]}_{with SDS}}$$

### pH Measurements

A Mettler-Toledo pH meter was used for the pH measurements.

### Viscosity

Viscosity measurements were carried out on a Haake RS 6000 rheometer with a plate-plate geometry and 60 mm diameter, equipped with a UTM controller, a Peltier TC81 and a Julabo F12-EH water bath. Data was evaluated with the Rheowin software. The sample was applied to the lower geometry at 25° C. A tube was used to remove any excess sample and the measurement was started. The dyna-mic viscosity at a shear rate of 100/s was obtained.

### Overrun

The overrun analyses of the samples were performed using a KitchenAid food processor. All analyses were carried out on samples having a temperature of 4° C. The same type of plastic beaker was al-ways used to weigh the samples. For this purpose, the beaker was placed on a balance and the balance was tared. The beaker was then filled to the top with the emulsion and the weight measured. 600 g of the emulsion was whipped in the KitchenAid on speed 8 for a certain time. The same plastic beaker was filled with whipped product to the top and the weight was measured again. The overrun was then calculated using the following formula:

$$Overrun = \frac{{mass}_{cream} - {mass}_{whipped cream}}{{mass}_{whipped cream}} \cdot 100 \%$$

Hardness (firmness)

A texture analyzer from Stable Micro Systems was used to determine the hardness of the whipped cream. For this purpose, the beakers filled with whipped cream for measuring the overrun were used and measured, and a pseudo-compression test was carried out. A cylindrical flat probe with a diameter of 35 mm penetrated the sample at a traverse speed of 0.5 mm/s to a depth of 25 mm. The maximum force (in g) was then calculated. Measurements was carried out at room temperature.

### Shape Retention

A part of the whipped cream was filled into a piping bag and rosettes were piped onto a black foil. A picture of piped rosette was taken with a camera. After 45 minutes a picture was taken again in order to assess the shape retention.

### Emulsions and Whipped Creams

An overview of the prepared o/w emulsions is provided in Table 4.

TABLE 4
Overview of prepared and tested o/w emulsions.

| Sample # | 1 | 2 | 3 | 4 | 5 | 6 | 7 | 8 | 9 |
|---|---|---|---|---|---|---|---|---|---|
| Water | 69.5% | 68.5% | 68.5% | 69.5 | 68.5% | 68.5% | 68.8% | 68.8% | 68.5% |
| Faba bean | 0.50% | | 1.50% | | | | | | |
| protein isolate | | | | | | | | | |
| Faba bean | | 1.50% | | | | | | | |
| protein concentrate | | | | | | | | | |
| Pea protein isolate | | | | 0.5% | | 1.5% | 1.2% | 1.2% | 1.5% |
| Pea protein | | | | | 1.5% | | | | |
| concentrate | | | | | | | | | |
| Fat blend 1 | 30% | 30% | 30% | 30% | 30% | 30% | 30% | | |
| (Hydrogenated palm kernel oil) | (24%) | (24%) | (24%) | (24%) | (24%) | (24%) | (24%) | | |
| (High oleic sunflower | (6%) | (6%) | (6%) | (6%) | (6%) | (6%) | (6%) | | |
| oil) | | | | | | | | | |
| Fat blend 2 | | | | | | | | 30% | 30% |
| (Chocofill NH 18) | | | | | | | | (27.5%) | (27.5%) |
| (Shea stearin) | | | | | | | | (2.5%) | (2.5%) |
| Laboratory scale | X | X | X | X | X | X | | | |
| Industrial scale | | | | | | X | X | X | X |

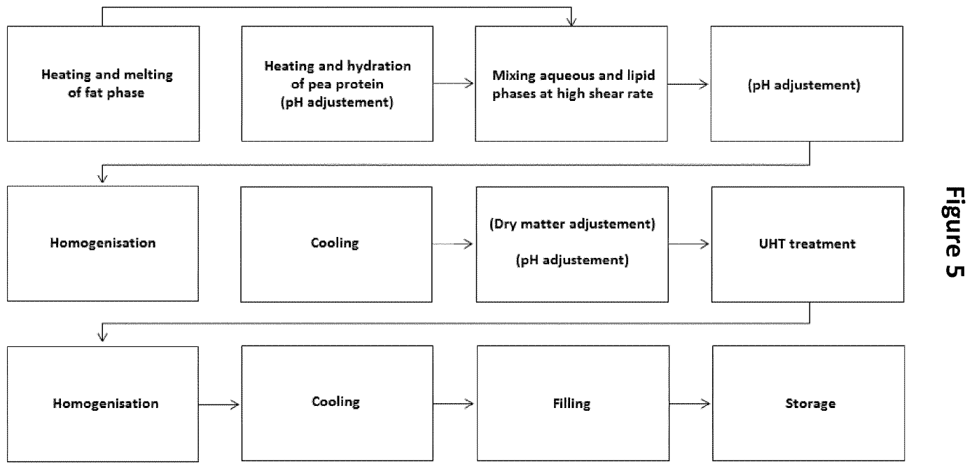

A flow sheet showing the process for preparing the emulsion of the invention is shown in FIG. 5.

### Example 1: Comparison of Pea Protein and Faba Bean Protein (Laboratory Scale

48 g pea protein isolate was dissolved in 2.75 kg water at 65° C. for 30 min and the pH was adjusted to 6.8 with citric acid. 0.96 kg hydrogenated palm kernel oil and 0.24 kg high oleic sunflower oil was melted at 60° C. (Fat blend 1). The aqueous and lipid phases were then mixed at high shear. This premix was homogenized at 100/20 bar, cooled to 20° C., UHT treated at 145° C. for 5 seconds, homogenized at 250/50 bar and cooled to 20° C. The product then was filled and stored. A part of the emulsion was whipped for a few minutes.

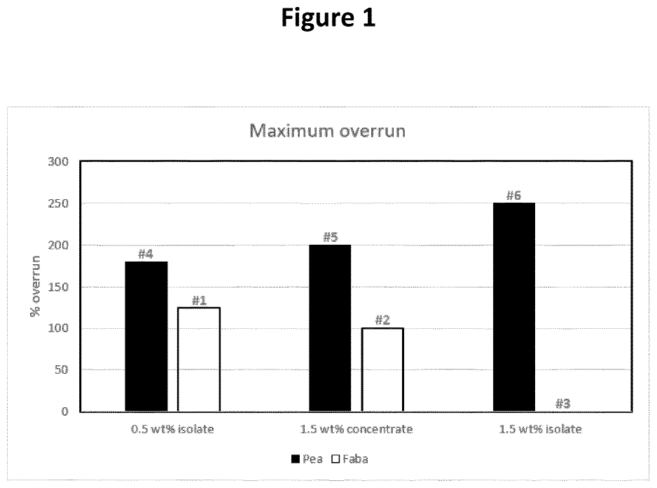

The results are shown in Table 5. The overrun results are also shown in FIG. 1.

TABLE 5
Results for samples #1 to #6 (laboratory scale).

| | | | | | | | Whipped |
|---|---|---|---|---|---|---|---|
| | | | Emulsion | | | | cream |
| Sample | Protein conc. | Protein source | Viscosity | D[4; 3] | D[4; 3]^{†} | Flocculation | Max. over- |
| # | (wt %) | added | (mPas) | (μm) | (μm) | factor | run (%) |

Faba bean protein

| | | | | | | | |
|---|---|---|---|---|---|---|---|
| 1 | 0.42 | 0.5 wt % isolate | 7.0 | 6.17 | 2.01 | 3.07 | 125 |
| 2 | 0.82 | 1.5 wt % conc. | 42.9 | 7.16 | 3.47 | 2.06 | 80 |

| | | | |
|---|---|---|---|
| 3 | 1.25 | 1.5 wt % isolate | Unstable emulsion |

Pea protein

| | | | | | | | |
|---|---|---|---|---|---|---|---|
| 4 | 0.39 | 0.5 wt % isolate | 4.78 | 3.14 | 2.44 | 1.29 | 180 |
| 5 | 0.78 | 1.5 wt % conc. | 6.23 | 1.64 | 1.45 | 1.13 | 200 |
| 6 | 1.16 | 1.5 wt % isolate | 7.58 | 1.02 | 0.83 | 250 | 250 |

^{†}Measured in the presence of SDS.

As it appears from Table 5 and FIG. 1 it was surprisingly observed that emulsions containing pea protein were superior in terms of overrun as compared to emulsions containing faba bean protein. It was observed that the overrun increased with increasing pea protein concentration, whereas the overrun decreased with increasing concentrations of faba bean protein. In particular, the emulsion containing 1.5 wt % faba bean protein isolate (1.25 wt % faba bean protein; #3) became unstable and excessively viscous. The emulsion containing 1.5 wt % faba bean protein concentrate (0.82 wt % faba bean protein; #2) was also highly viscous, but could still be whipped. Emulsion #2 showed, however, the lowest overrun.

It is also apparent from Table 5 that the viscosity, fat droplet size and flocculation were lower for the emulsions containing pea protein than for the emulsions containing faba bean protein. According to Stoke's law, the creaming rate depends on the square of the diameter of the fat droplets, and the smaller fat droplet mean diameter observed for the emulsions containing pea protein therefore likely contributes to the stability of the pea-based emulsions and the higher overrun of the whipped pea-based creams.

The firmness (hardness) of the whipped faba bean protein emulsions #1 and #2 was generally too low (<50 g) even after whipping for 5 minutes. The firmness of the whipped faba bean protein emulsion #3 was good (100 to 200 g after whipping for 4 to 5 minutes).

The firmness (hardness) of the whipped pea protein emulsions #4, #5 and #6 was generally good with firmness values in the range from 50 to 200 g after whipping for 4 to 5 minutes.

In view of the superior properties of the pea protein as compared to the faba bean protein, industrial scale trials were performed with o/w emulsions containing different pea protein concentrations and different fat blends.

### Example 2: Pea Protein Trials on Industrial Scale

4 kg pea protein isolate was dissolved in 140 kg water at 65° cfor 15 min. 68.75 kg Chocofill NH 18 and 6.25 kg shea stearin was melted at 65° C. (Fat blend 2). The aqueous and lipid phases were then mixed at high shear. This premix was homogenized at 100/20 bar, cooled to 20° C., where after the dry-matter content was adjusted to 31.2% and the pH was adjusted to pH 6.8 with citric acid. The product was then UHT treated at 145° C. for 5 seconds, homogenized at 250/50 bar and cooled to 20° C. The product then was filled and stored. A part of the emulsion was whipped for a few minutes.

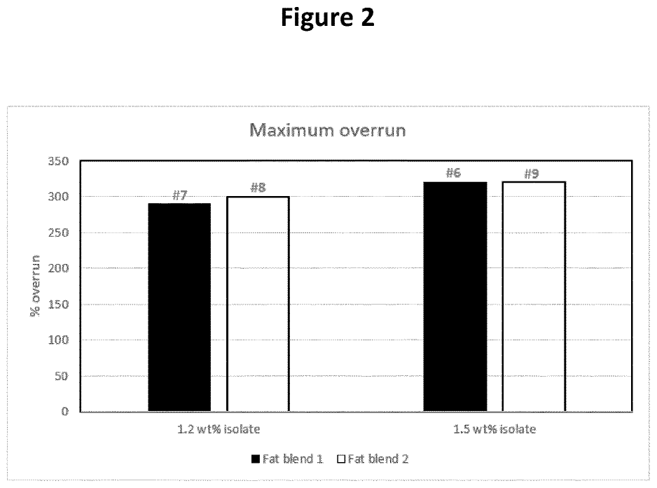

The results are shown in Table 6. The overrun results are also shown in FIG. 2.

As it appears from the data in Table 6 and FIG. 2, similar results were obtained irrespective of whether 1.2 or 1.5 wt % pea protein isolate (0.92 or 1.16 wt % pea protein) was used in the emulsions, and irrespective of whether Fat blends 1 or 2 were used.

The firmness (hardness) of all of the whipped pea protein emulsions was good with firmness values in the range from 100 to 300 g after whipping for 3 to 4 minutes.

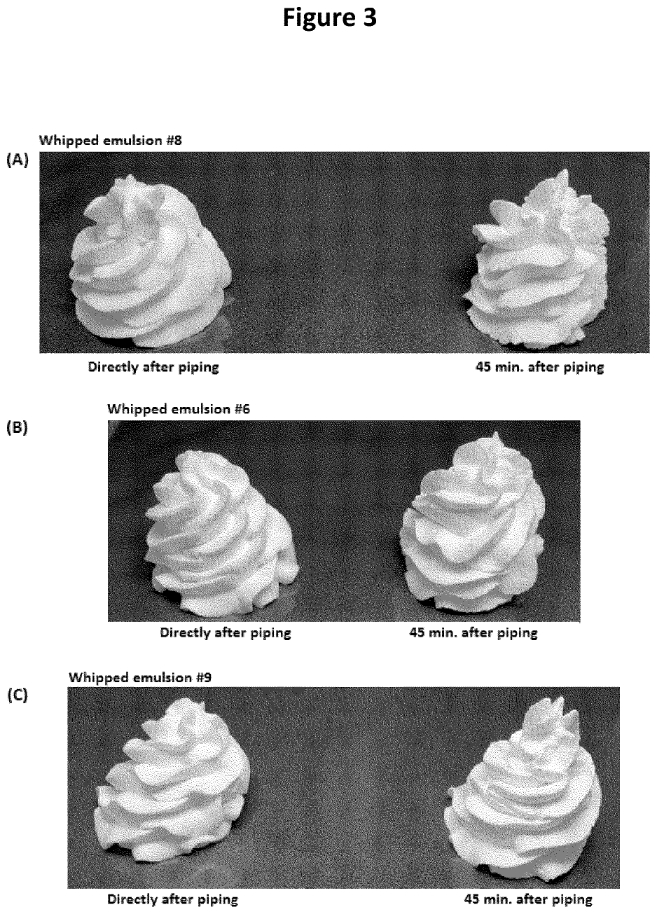

The shape retention of the whipped creams was excellent as shown in FIG. 3.

Moreover, the fact that the properties and the measured parameters of emulsion #6 were largely independent of whether the process was carried out in laboratory scale or on an industrial scale shows the manufacturing process is surprisingly robust.

TABLE 6
Results for samples #6 to #9 (industrial scale).

| | | | | | | | Whipped |
|---|---|---|---|---|---|---|---|
| | | | Emulsion | | | | cream |
| Sample | Pea protein | Pea protein | Viscosity | D[4; 3] | D[4; 3]^{†} | Flocculation | Max. over- |
| # | conc. (wt %) | source added | (mPas) | (μm) | (μm) | factor | run (%) |

Fat Blend 1

| | | | | | | | |
|---|---|---|---|---|---|---|---|
| 7 | 0.92 | 1.2 wt % isolate | 9.06 | 1.03 | 0.76 | 1.36 | 290 |
| 6 | 1.16 | 1.5 wt % isolate | 9.29 | 0.98 | 0.65 | 1.51 | 320 |

Fat blend 2

| | | | | | | | |
|---|---|---|---|---|---|---|---|
| 8 | 0.92 | 1.2 wt % isolate | 9.58 | 1.05 | 0.74 | 1.42 | 300 |
| 9 | 1.16 | 1.5 wt % isolate | 13.36 | 0.98 | 0.60 | 1.63 | 320 |

^{†}Measured in the presence of SDS.

### Example 3: Application Tests

Emulsion #8, i.e. the emulsion containing 1.2 wt % pea protein isolate and Fat blend 2, was tested in three different applications.

Emulsion 8 was tested in a mushroom cream sauce made with white wine. This allowed the pH sensi-tivity of the emulsion to be tested. The emulsion remained stable despite heating and the low pH of below 4. The emulsion also showed a good coating on the pasta.

In addition, the emulsion was tested in a tomato cream soup in order to assess the whitening effect compared to a milk-based whipping cream. No significant differences in colour and taste were found between the two soups.

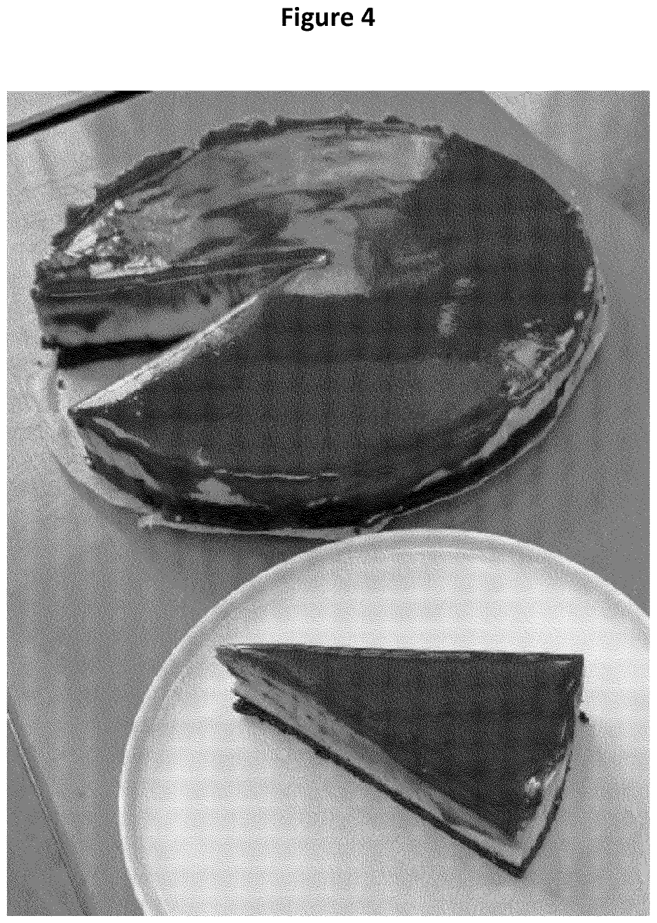

Finally, the whipped emulsion #8 was used in a vegan cheesecake as shown in FIG. 4. The application of the whipped emulsion in a cheesecake did not incur any problems, and an excellent end result was obtained both from a visual and from a taste perspective.

1. An edible oil-in-water (o/w) emulsion comprising, based on the total weight of the emulsion,
(a) from 50 to 80 wt % of an aqueous phase,
(b) from 20 to 50 wt % of a vegetable lipid phase, and
(c) from 0.25 to 1.50 wt % plant-based protein,
(d) optionally an acidity regulator,
wherein pea protein constitutes at least 50 wt % of all plant-based proteins present in the emulsion, and
wherein said emulsion is substantially free from ingredients of dairy and animal origin.

2. The emulsion according to claim 1, wherein pea protein is the only protein in said emulsion.

3. The emulsion according to claim 1, wherein said emulsion is substantially free from thickeners and/or stabilisers and/or emulsifiers with the exception of said plant-based protein.

4. The emulsion according to claim 1, wherein pea protein is the only protein in said emulsion, and wherein said emulsion is substantially free from thickeners and/or stabilisers and/or emulsifiers with the exception of said pea protein.

5. The emulsion according to claim 1, wherein said vegetable lipid phase comprises a blend of a vegetable liquid oil and a vegetable solid fat.

6. The emulsion according to claim 5, wherein said blend contains from 10 to 30 wt % vegetable liquid oil and from 70 to 90 wt % vegetable solid fat.

7. The emulsion according to claim 5, wherein said blend contains from 30 to 50% vegetable liquid oil, and from 50 to 70% solid fat.

8. The emulsion according to claim 1, wherein said vegetable lipid phase comprises a blend of a first vegetable solid fat and a second vegetable solid fat.

9. The emulsion according to claim 8, wherein said first vegetable solid fat is present in the blend in an amount from 80 to 99 wt %, and said second vegetable solid fat is present in the blend in an amount from 1 to 20 wt %.

10. The emulsion according to claim 5, wherein said blend has a vegetable solid fat content (SFC) of at least 50 wt % at 20° C.

11. The emulsion according to claim 6, wherein said blend has a vegetable solid fat content (SFC) of 40 to 60 wt. % at 20° C.

12. The emulsion according to claim 1 comprising an acidity regulator.

13. A whipped cream obtainable by whipping the emulsion according to claim 1.

14. A whipped cream obtainable by incorporating air into the emulsion according to claim 1.

15. A food product comprising the emulsion according to claim 1.

16. A food product comprising the whipped cream according to claim 13.

17. A process for the manufacture of an edible oil-in-water (o/w) emulsion according to claim 1 comprising the following steps:
(a) providing and heating a vegetable lipid phase;
(b) providing, and optionally heating, an aqueous phase, comprising a plant-based protein, wherein pea protein constitutes at least 50 wt % of all plant-based proteins present in the aqueous phase;
(c) mixing said aqueous and vegetable lipid phases so as to form a pre-emulsion;
(d) homogenising said pre-emulsion obtained in step (c) so as to obtain an o/w emulsion;
(e) cooling said emulsion obtained in step (d);
(f) subjecting said cooled emulsion obtained in step (e) to UHT treatment;
(g) homogenising said UHT-treated emulsion obtained in step (f); and
(h) cooling said homogenised and UHT-treated emulsion obtained in step (g),
wherein the pH may optionally be adjusted by an acidity regulator after any of steps (b) to (h) so as to obtain a pH in the range from 6.5 to 7.5.

18. The emulsion according to claim 1, said emulsion is free from ingredients of dairy and animal origin.

19. The emulsion according to claim 4, wherein said emulsion is free from thickeners, stabilisers, and emulsifiers with the exception of said pea protein.

20. The emulsion according to claim 5, wherein said vegetable lipid phase consists of a blend of a vegetable liquid oil and a vegetable solid fat.
